(19) United States
(12) Patent Application Publication
(10) Pub. No.: US 2019/0128421 A1
(43) Pub. Date: May 2, 2019

(54) GAS-CURTAIN PROTECTION DEVICE FOR AEROSPACE PRECISION MACHINING SPINDLE

(71) Applicant: Royal Precision Tools Corporation, Taichung City (TW)

(72) Inventor: CHUI-HSI TSAI, Taichung City (TW)

(21) Appl. No.: 15/794,979

(22) Filed: Oct. 26, 2017

(51) Int. Cl. F16J 15/00; F16J 15/447; F16J 15/40

(52) U.S. Cl. CPC F16J 15/002; B23Q 5/04; F16J 15/40; F16J 15/447

(57) ABSTRACT

A gas-curtain protection device for an aerospace precision machining spindle includes a spindle body, a shaft, a first labyrinth ring, a gas guide ring and a bulkhead ring. The first labyrinth ring and the gas guide ring are mounted around the front end of the spindle body, and the bulkhead ring is mounted around the shaft. The first labyrinth ring has a gas pipe, and the gas guide ring has a gas tank communicated with the gas pipe. The bulkhead ring has a gas guide structure communicated with the gas tank. In use, gas is delivered from the spindle body to the gas tank through the gas pipe, and then guided to the exterior of the spindle body by the gas guide structure so as to form a gas curtain that effectively prevents cutting fluid and chips from entering the interior of the spindle body.

### BACKGROUND OF THE INVENTION

### 1. Technical Field

The present invention relates to machining centers, and more particularly to a gas-curtain protection device for an aerospace precision machining spindle. The gas-curtain protection device forms a gas curtain outside the spindle's body to prevent liquid from entering the spindle body.

### 2. Description of Related Art

During metal machining, heat is generated by friction between tool and workpiece to be machined, and thus a cutting fluid is used to reduce such friction, to remove such heat from the cutting area, to lower the cutting temperature, and to minimize abrasion of the tool. This known approach is proven to improve durability of tools and prevent chips from being welded onto tools to adversely affect subsequent cutting, thereby increasing productivity, decreasing workpieces roughness, and ensuring machining accuracy.

Moreover, a great quantity of dust can be generated during metal machining, and it is known to have a labyrinth seal assembled to the front end of the spindle body for blocking cutting fluid and dust from entering the interior of spindle body and adversely affecting cutting. However, while such a labyrinth seal does prevent cutting fluid and dust from entering, it is not able to prevent backwash of cutting fluid completely, and such backwash can cause cutting fluid to enter, contaminate and damage the spindle body.

### SUMMARY OF THE INVENTION

To address the foregoing issue, the present invention provides a gas-curtain protection device for an aerospace precision machining spindle, which forms a gas curtain outside the spindle body by blowing gas from the spindle body to the exterior, and uses labyrinth rings to form complete peripheral sealing that prevents minute chips and cutting fluid from entering the spindle body, so as to provide dual protection.

In one embodiment of the present invention, a gas-curtain protection device for an aerospace precision machining spindle comprises: a spindle body, being provided with a rotatable shaft and having a front end and a rear end that are opposite to each other; a first labyrinth ring, being mounted around the front end of the spindle body and including a gas pipe; a gas guide ring, being mounted around the front end of the spindle body and adjacent to the first labyrinth ring, and having its lateral facing the rear end circularly formed with a gas tank that is communicated with the gas pipe; and a bulkhead ring, being mounted around the shaft, close to the front end, and adjacent to the gas guide ring, wherein a gas guide structure communicated with the gas tank is formed between the bulkhead ring and the gas guide ring, whereby a gas delivered from the spindle body to the gas tank through the gas pipe is guided by the gas guide structure to the exterior of the spindle body to from a gas curtain.

With the foregoing configuration, gas delivered to the gas tank through the gas pipe from the interior of the spindle body is guided to the exterior of the spindle body by the gas guide structure, and forms a gas curtain outside the spindle body. By delivering gas from the interior of the spindle body to the exterior, chips and cutting fluid are prevented from entering the spindle body, so that the problem of the prior art where foreign objects often enter the spindle body to cause damage can be solved. In addition, the first labyrinth ring assembled to the front end of the spindle body forms complete peripheral sealing that effectively prevents minute chips and cutting fluid from entering the spindle body, so as to provide dual protection.

In one embodiment of the present invention, a first gas passage is formed between a lateral of the gas guide ring that faces the rear end and the first labyrinth ring. The first gas passage is communicated with gas tank and the gas guide structure. The gas guide structure has an invaginated plane circularly formed at the outer periphery of the bulkhead ring. The first gas passage is pointed to the invaginated plane. When the gas is delivered to the gas guide structure from the gas tank through the first gas passage, the invaginated plane redirects all of the gas and aims it at the exterior of the spindle body, so that the gas can be evenly output to the exterior of the spindle body and form a complete gas curtain there to effectively prevent chips and cutting fluid from entering the interior of the spindle body.

In one embodiment of the present invention, the gas guide structure has a second gas passage between the bulkhead ring and the gas guide ring. The second gas passage is parallel to the axial direction of the spindle body. The first gas passage is communicated with the second gas passage and the gas tank. The bulkhead ring has its outer periphery circularly formed with a bulkhead to cover the opening of the second gas passage. Thereby, when the spindle body rotates to rotate the bulkhead ring, the bulkhead of the bulkhead ring can provide enhanced water-throwing capacity, thereby effectively preventing the cutting fluid from entering the spindle body and enhancing protection.

In one embodiment of the present invention, the device further comprises a second labyrinth ring, which is mounted around and connected to the shaft. The bulkhead ring is connected to the second labyrinth ring, while the bulkhead ring and the shaft are fixed to each other. With two labyrinth-like structures at the front end of spindle body, the first labyrinth ring and the second labyrinth ring use their labyrinthian configurations to effectively prevent the cutting fluid from permeating into or being sprayed into the interior of the spindle body, while the gas guide ring and the bulkhead ring provide a further layer of protection.

To assemble the first labyrinth ring, the second labyrinth ring, the gas guide ring, and the bulkhead ring to the spindle body and the shaft, the following steps are conducted. First, the first labyrinth ring is assembled to the front end of the spindle body. Then the second labyrinth ring and the shaft are fixed. Afterward, the gas guide ring and the first labyrinth ring are connected. At last, the bulkhead ring is connected to the shaft and the second labyrinth ring. For disassembly, the bulkhead ring, the gas guide ring, the second labyrinth ring, and the first labyrinth ring are detached from the spindle body and the shaft successively. Thus, the assembly and disassembly of the device are simple and easy.

### BRIEF DESCRIPTION OF THE DRAWINGS

FIG. 1 is a partial, cross-sectional view of a spindle body according to the present invention.

FIG. 2 is a partial, exploded, cross-sectional view of the gas-curtain protection device of the present invention.

FIG. 3 is a cross-sectional view of the gas-curtain protection device of the present invention.

FIG. 4 is a partial, enlargement of FIG. 3.

FIG. 5 is a schematic drawing showing gas delivered outward from the spindle to form a gas curtain according to the present invention.

FIG. 6 is an applied view of the gas-curtain protection device of the present invention.

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale.

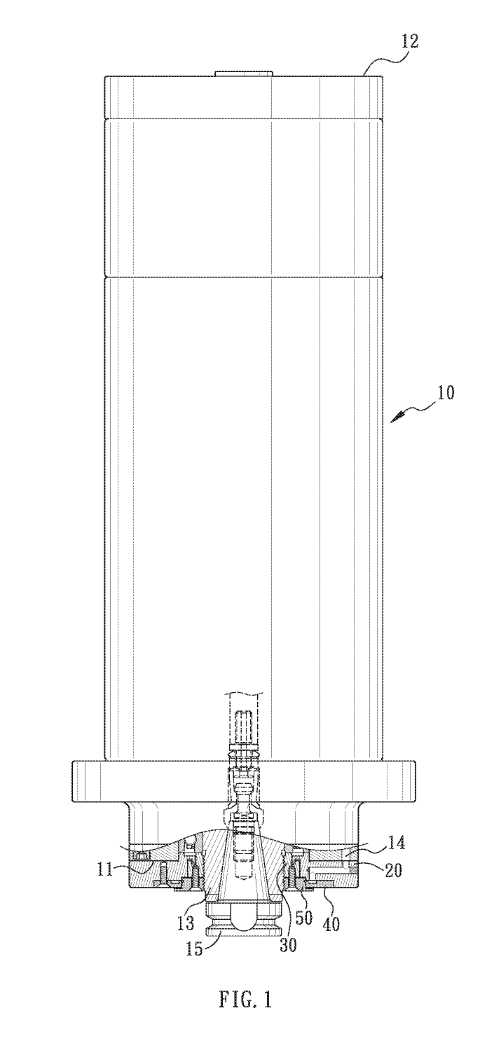

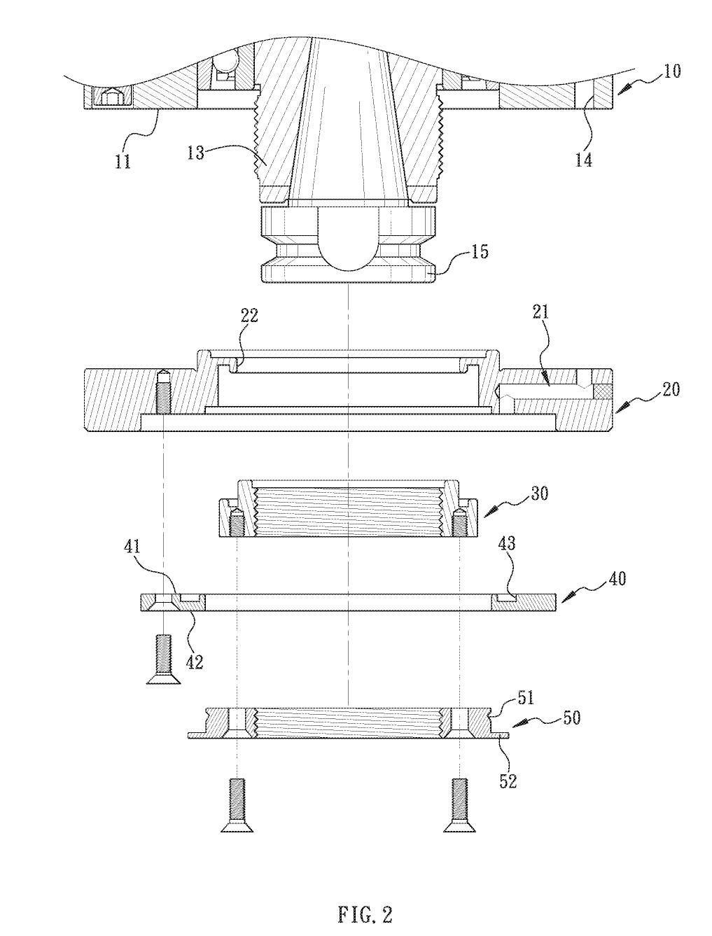

Referring to FIG. 1 through FIG. 6, the present invention discloses a gas-curtain protection device for an aerospace precision machining spindle installed on a machining center. The gas-curtain protection device comprises a spindle body 10, a first labyrinth ring 20, a second labyrinth ring 30, a gas guide ring 40, and a bulkhead ring 50.

The spindle body 10 has a front end 11 and a rear end 12 that are opposite to each other against the axial direction of the spindle body 10. The spindle body 10 has a rotatable shaft 13 and a gas-blowing channel 14. In one embodiment of the present invention, it is an air compressor that provides the gas-blowing channel 14 with gas 1. Furthermore, the shaft 13 is configured to receive a tool holder 15 that holds a tool 16. As the spindle body 10 drives the shaft 13 to rotate, the shaft 13 drives the tool holder 15 to rotate, so that the tool 16 machines a workpiece 2. During machining, a cutting fluid 3 is provided for cooling.

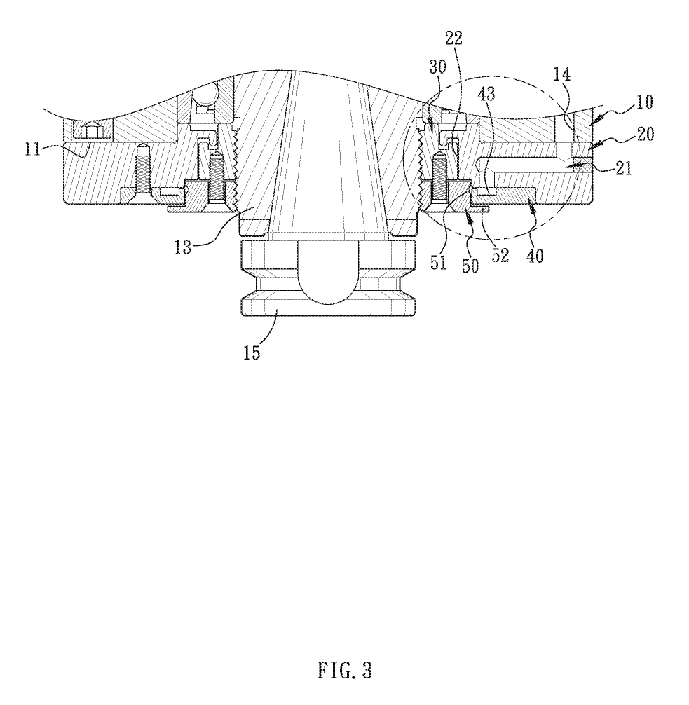

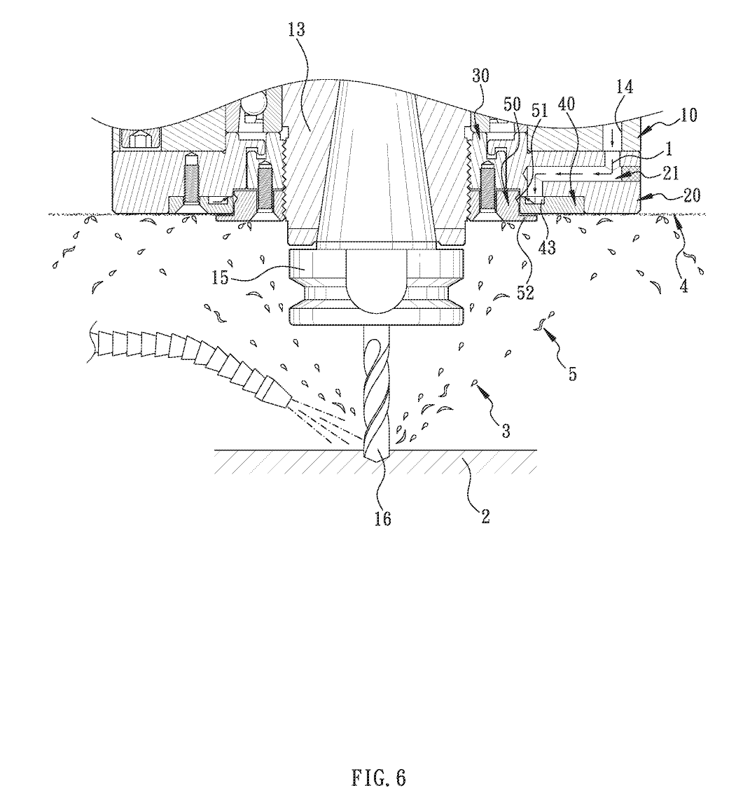

The first labyrinth ring 20 is mounted around the front end 11 of the spindle body 10. In one embodiment of the present invention, the first labyrinth ring 20 is screwed to the front end 11 of the spindle body 10. The first labyrinth ring 20 has a gas pipe 21 that is communicated with the gas-blowing channel 14, so as to allow the gas 1 to be delivered to the gas pipe 21 of the first labyrinth ring 20 through the gas-blowing channel 14 of the spindle body 10. The first labyrinth ring 20 is axially formed with an axial hole 22 whose inner periphery is provided with a bent, labyrinth-like structure for preventing the cutting fluid 3 from permeating or gushing into the spindle body 10, as shown in FIG. 3 and FIG. 6.

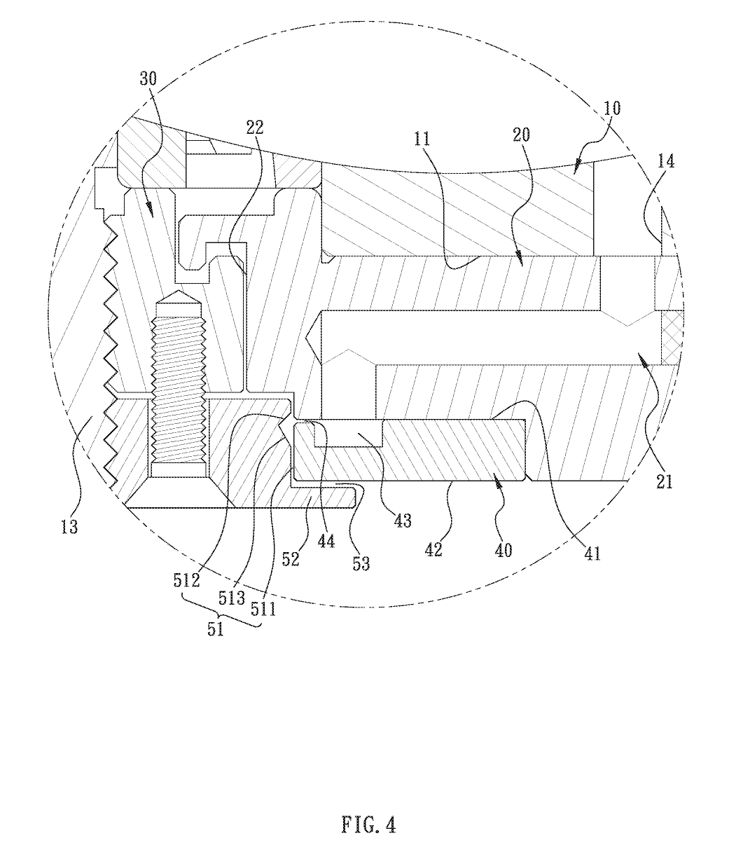

The second labyrinth ring 30 is mounted around and connected to the shaft 13. In one embodiment of the present invention, the second labyrinth ring 30 is screwed onto the shaft 13. The second labyrinth ring 30 has a labyrinth-like structure shaped to mate with the first labyrinth ring 20. The first labyrinth ring 20 and the second labyrinth ring 30 are engaged with each other by means of their labyrinth-like structures, thereby preventing the cutting fluid 3 from permeating or gushing into the spindle body 10, as shown in FIG. 4 and FIG. 6.

The gas guide ring 40 is mounted around the front end 11 of the spindle body 10 and is adjacent to the first labyrinth ring 20. In one embodiment of the present invention, the gas guide ring 40 and the first labyrinth ring 20 are fixed. The gas guide ring 40 has an inner lateral 41 and an outer lateral 42. The inner lateral 41 faces the rear end 12 of the spindle body 10, and the outer lateral 42 faces the front end 11 of the spindle body 10. The gas guide ring 40 has a gas tank 43 circularly formed near and along its inner lateral 41. The gas tank 43 is communicated with the gas pipe 21. Moreover, a first gas passage 44 is formed as a gap between the inner lateral 41 of the gas guide ring 40 and the first labyrinth ring 20. The first gas passage 44 is communicated with the gas tank 43. In one embodiment of the present invention, the first gas passage 44 is perpendicular to the axial direction of the spindle body 10.

The bulkhead ring 50 is mounted around the shaft 13 and close to the front end 11 of the spindle body 10. The bulkhead ring 50 is adjacent to the gas guide ring 40. In one embodiment of the present invention, the bulkhead ring 50 is screwed to the shaft 13, and is fixed to the second labyrinth ring 30. The bulkhead ring 50 has its outer periphery circularly provided with a gas guide structure 51 that is communicated with the gas tank 43. Thereby, when the gas 1 enters the gas tank 43 via the gas pipe 21 and passes through the gas guide structure 51, the gas guide structure 51 guides the gas 1 to the exterior of the spindle body 10 to form a gas curtain 4, as shown in FIG. 4 through FIG. 6.

Furthermore, the gas guide structure 51 has a second gas passage 511. When the bulkhead ring 50 is mounted around the shaft 13, a second gas passage 511 is formed as a gap between the outer periphery of the bulkhead ring 50 that is not facing the shaft 13 and the inner periphery of the gas guide ring 40 that is facing the shaft 13. The first gas passage 44 is communicated with the second gas passage 511 and the gas tank 43. In one embodiment of the present invention, the second gas passage 511 is parallel to the axial direction of the spindle body 10.

The gas guide structure 51 further has an invaginated plane 512 and a guide plane 513. The invaginated plane 512 and the guide plane 513 are inclined to each other to jointly form a V-shaped structure. The first gas passage 44 is pointed to the invaginated plane 512. Therein, the invaginated plane 512 and the axis of the spindle body 10 include a first included angle A. The first included angle A is between 35 degrees and 50 degrees. The guide plane 513 and the axis of the spindle body 10 include a second included angle B. The second included angle B is between 25 degrees and 35 degrees. In one embodiment of the present invention, the first included angle A is 45 degrees, and the second included angle B is 30 degrees. The included angle between the invaginated plane 512 and the guide plane 513 is 105 degrees.

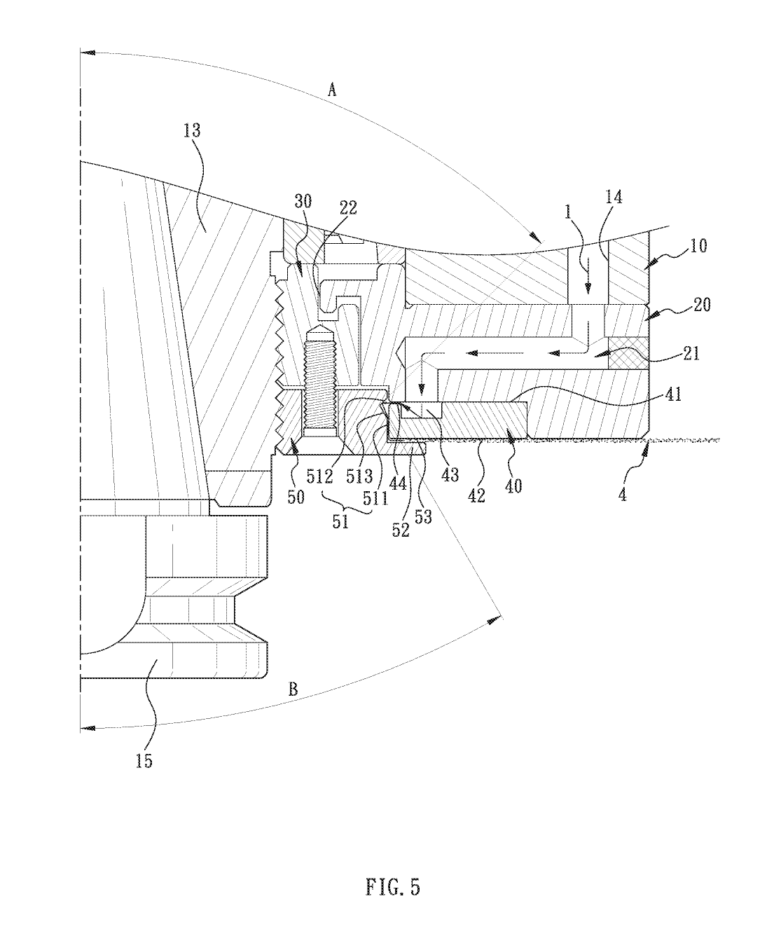

With the specific angles of inclination of the invaginated plane 512 and the guide plane 513, when entering the gas guide structure 51 through the first gas passage 44, all the gas 1 hitting the invaginated plane 512 is redirected to and aimed at the guide plane 513, and guided evenly by the guide plane 513 to the exterior of the spindle body 10, as shown in FIG. 4 and FIG. 5.

In addition, the bulkhead ring 50 has a bulkhead 52 circularly raised from its outer periphery. The bulkhead 52 extends outward and covers the opening of the second gas passage 511. A third gas passage 53 is formed between the bulkhead 52 and the gas guide ring 40 with its opening facing the outer periphery of the spindle body 10. The third gas passage 53 is communicated with the second gas passage 511. In one embodiment of the present invention, the third gas passage 53 and the second gas passage 511 are perpendicular to each other, while the second gas passage 511 and the third gas passage 53 are connected to form an L-shaped structure, as shown in FIG. 4.

Referring to FIG. 4 through FIG. 6, when the spindle body 10 rotates the shaft 13 to make the tool 16 machine the workpiece 2, the cutting fluid 3 is sprayed onto the tool 16 for cooling. At the same time, the gas 1 is delivered to the gas pipe 21 of the first labyrinth ring 20 through the gas-blowing channel 14 of the spindle body 10. The gas 1 is collected at the gas tank 43 by means of the gas pipe 21. When the gas 1 then moves toward the first gas passage 44 and enters the gas guide structure 51, the invaginated plane 512 redirects and aims all of the gas 1 to the guide plane 513, so that the gas 1 is evenly guided by the guide plane 513 to the second gas passage 511, and goes to the exterior of the bulkhead ring 50 through the third gas passage 53, thereby forming a complete gas curtain 4 at the outer lateral 42 of the gas guide ring 40.

Thereby, when hitting the gas curtain, the cutting fluid 3 or chips 5 are ricocheted and effectively blocked. Also, with the first labyrinth ring 20 and the second labyrinth ring 30 assembled to the front end 11 of the spindle body 10, the front end 11 of the spindle body 10 is fully sealed at its periphery, thereby providing one more layer of protection and preventing chips 5 and the cutting fluid 3 from entering the spindle body 10.

Furthermore, when the spindle body 10 rotates to rotate the bulkhead ring 50, the bulkhead 52 of the bulkhead ring 50 can throw away the cutting fluid 3 casted toward the front end 11 of the spindle body 10 with enhanced water-throwing capacity, thereby effectively preventing the cutting fluid 3 from entering the spindle body 10 and enhancing protection.

To assemble the first labyrinth ring 20, the second labyrinth ring 30, the gas guide ring 40, and the bulkhead ring 50 to the spindle body 10 and the shaft 13, the following steps are conducted. First, the first labyrinth ring 20 is assembled to the front end 11 of the spindle body 10. Then the second labyrinth ring 30 and the shaft 13 are fixed. Afterward, the gas guide ring 40 and the first labyrinth ring 20 are connected. At last, the bulkhead ring 50 is connected to the shaft 13 and the second labyrinth ring 30. For disassembly, the bulkhead ring 50, the gas guide ring 40, the second labyrinth ring 30, and the first labyrinth ring 20 are detached from the spindle body 10 and the shaft 13 successively. Thus, the assembly and disassembly of the device are simple and easy.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A gas-curtain protection device for an aerospace precision machining spindle comprising:
a spindle body, being provided with a rotatable shaft and having a front end and a rear end that are opposite to each other;
a first labyrinth ring, being mounted around the front end of the spindle body and including a gas pipe;
a gas guide ring, being mounted around the front end of the spindle body and adjacent to the first labyrinth ring, and having its lateral facing the rear end circularly formed with a gas tank that is communicated with the gas pipe; and
a bulkhead ring, being mounted around the shaft, close to the front end, and adjacent to the gas guide ring, wherein a gas guide structure communicated with the gas tank is formed between the bulkhead ring and the gas guide ring, whereby a gas delivered from the spindle body to the gas tank through the gas pipe is guided by the gas guide structure to the exterior of the spindle body to from a gas curtain.

2. The gas-curtain protection device of claim 1, wherein a first gas passage is formed between a lateral of the gas guide ring that faces the rear end and the first labyrinth ring, in which the first gas passage is communicated with the gas tank and the gas guide structure.

3. The gas-curtain protection device of claim 1, wherein a first gas passage is formed between a lateral of the gas guide ring that faces the rear end and the first labyrinth ring, and the gas guide structure has a second gas passage that is between the bulkhead ring and the gas guide ring, in which the second gas passage is parallel to an axial direction of the spindle body, and the first gas passage is communicated with the second gas passage and the gas tank.

4. The gas-curtain protection device of claim 3, wherein the gas guide structure has an invaginated plane that is circularly formed at an outer periphery of the bulkhead ring, and the first gas passage is pointed to the invaginated plane.

5. The gas-curtain protection device of claim 4, wherein the gas guide structure further has a guide plane circularly formed at the outer periphery of the bulkhead ring and connected to the invaginated plane to jointly form a V-shaped structure.

6. The gas-curtain protection device of claim 5, wherein the invaginated plane and an axis of the spindle body include a first included angle, which is between 35 degrees and 50 degrees, while the guide plane and the axis of the spindle body include a second included angle, which is between 25 degrees and 35 degrees.

7. The gas-curtain protection device of claim 3, wherein a bulkhead is circularly raised from an outer periphery of the bulkhead ring to cover an opening of the second gas passage.

8. The gas-curtain protection device of claim 7, wherein a third gas passage is formed between the bulkhead and the gas guide ring and has an opening facing an outer periphery of the spindle body, in which the third gas passage is communicated with the second gas passage, and the third gas passage and the second gas passage is perpendicular to each other.

9. The gas-curtain protection device of claim 1, wherein the spindle body has a gas-blowing channel communicated with the gas pipe for delivering the gas.

10. The gas-curtain protection device of claim 1, further comprising a second labyrinth ring is mounted around and connected to the shaft, wherein the bulkhead ring is connected to the second labyrinth ring, while the bulkhead ring and the shaft are fixed to each other.
